(19) United States
(12) Patent Application Publication
(10) Pub. No.: US 2022/0287269 A1
(43) Pub. Date: Sep. 15, 2022

(54) ANIMAL FEEDER

(71) Applicants: Leslie P. Duke, Lindale, GA (US); Savannah G. Marion, Lindale, GA (US)

(72) Inventors: Leslie P. Duke, Lindale, GA (US); Savannah G. Marion, Lindale, GA (US)

(21) Appl. No.: 17/196,370

(22) Filed: Mar. 9, 2021

(51) Int. Cl. A01K 5/01

(52) U.S. Cl. CPC A01K 5/01

(57) ABSTRACT

An animal feeder includes a generally rectangular housing having a floor, four sidewalls, and a slanted roof. One of the sidewalls includes a pivotal door for access to the interior of the housing. Each sidewall has an arched feeding opening therethrough extending upwardly from the housing floor. The housing is mounted to a pair of underlying skids. A hitch receiver is mounted to the housing. The animal feeder also has a divider wall extending outwardly from each corner of the housing. A netting may be mounted to the interior of the housing.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The present inventive concept relates to the field of an animal feeders. More particularly, the invention relates to a large animal hay feeder.

### Technology in the Field of the Invention

The owner of large animals, such as horses, cattle, goats or sheep, must feed their animals on a daily basis. These animals typically eat hay, or the like, that is delivered to the feeding site in bales. These bales of hay, or other feed material, may vary in size and shape.

The bales of hay must be kept dry to avoid the growth of mold on the hay. The hay must also remain dry to prevent health issues relating to animals ingesting wet hay. However, the bales of hay must also be shaded to prevent the hay from drying out in direct sunlight. As such, the bales of hay may be placed under a shelter. However, the constant passage of animals to the hay creates a muddied area at the shelter. This requires the movement of the shelter or the use of multiple shelters in different locations so that each shelter is used only for only a select period of time.

Temporary shelters have also been designed to fit over a large bail of hay. However, these shelters are typically made of a plastic material, which may cause the shelter to blow over in a strong wind. These shelters also require a person to lift the shelter in order to place it over the large hay bale. This task may be too large and dangerous for an individual.

Accordingly, a need exists for an animal feeder that may maintain bales of hay in a dry condition while allowing unencumbered access for the animal to the hay. It is to the provision of such therefore that the present invention is primarily directed.

### BRIEF SUMMARY OF THE INVENTION

An animal feeder comprises a movable housing having a floor, a roof, and a plurality of sidewalls extending between the floor and the roof, one of the sidewalls includes a door movable between an open position and a closed position, at least one sidewall has a feeding opening therethrough providing access to the interior of the housing through the feeding opening.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an animal feeder embodying principles of the invention in a preferred form.

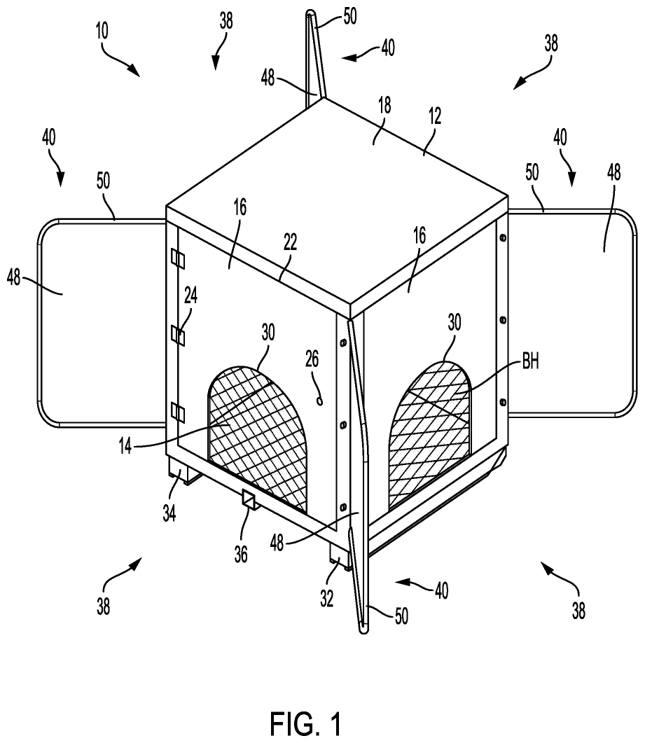

FIG. 2 is a top view of the animal feeder of FIG. 1, shown with a roof removed for clarity.

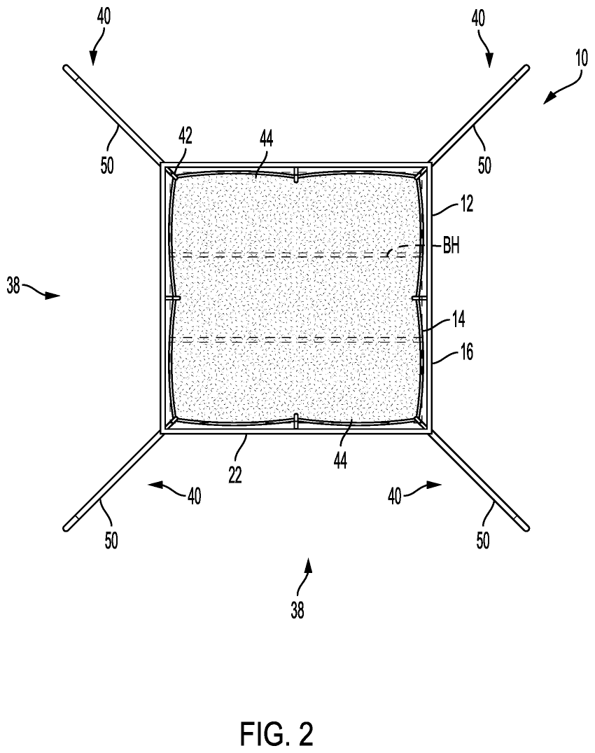

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown an animal feeder 10 in a preferred form of the present invention. The animal feeder 10 includes a generally rectangular, metal enclosure or housing 12 having a floor 14, four sidewalls 16, and a slanted roof 18. One of the sidewalls 16 includes a pivotal door 22 having three pivot hinges 24 and a lock or latch 26 oppositely disposed from the hinges 24. The door 22 provides access to the interior space of the housing 12.

Each sidewall 16, including the sidewall 16 having the door 22 therein, has an arched feeding opening 30. The feeding opening 30 is arched to provide a smooth area for animal contact during feeding through the feeding opening 30.

The housing 12 is mounted to a pair of underlying, elongated skids or pontoons 32. The skids 32 are made of a metal and may include a metal foot 34 mounted to the bottom side of the skid 32 to provide an extra layer of protection when moving the animal feeder 10 upon the skids 32. A hitch receiver 36 is mounted to the housing 12 between the two skids 32, which enable multiple animal feeders 10 to be coupled in tandem for common movement through conventionally know hitches, shackles, chains, linkage, or the like.

The animal feeder 10 also has a divider, wing, separator, or wall 40 extending outwardly from each corner of the housing 12. The divider walls 40 may include a somewhat flexible central portion 48 and a peripheral rounded frame portion 50. The frame portion 50 is rounded to prevent any sharp edges from injuring the animal while also providing support to the central portion 48. The divider walls 40 are intended to be somewhat flexible so that they flex and absorb the force of any animal accidentally hits the divider walls, thereby preventing injury to the animal as a consequence of such accidental contact. The divider walls 40 may be removably mounted to the housing 12, as through a mounting pin coupled to the divider that fits within a pin receiver mounted to the corner of the housing or through mounting bolts and nuts that may be removed to disconnect the divider walls 40 from the remaining portion of the housing 12. The combination of the housing 12 and divider walls 40 forms four separate feeding areas or stalls 38, with each stall 38 having a feeding opening 30.

Multiple mounting eyelets, hooks, or rings 42 may be coupled to the interior surface of the housing 12 just above the top of the feeding openings 30. The eyelets 42 provide a mounting point for an optional cup-shaped netting 44 configured to control the consumption rate of the hay behind the netting 44. The netting 44 may be coupled to the eyelets 42 through clips, string, couplers, or the like. The netting 44 surrounds the bales of hay within the bottom third of the housing 12 and is positioned between the bales of hay BH and the housing sidewalls 16 and floor 14, specifically the arched feeding openings 30. The netting 44 has a size and shape, or interstices, that allow a limited amount of hay to pass through the netting to control the speed and amount of hay consumption by the animal.

In use, netting 44 is coupled to the eyelets 42 so that the netting 44 closely overlays the bottom portion of the interior surface of the housing 12 except in the location of the door 22. With the door 22 pivoted to its open position, bales of hay BH are placed into the interior of the housing 12. The netting 44 is then draped across the hay in the position of the door feeding opening 30. The door 22 is then pivoted back to its closed position where it is then locked or latched to prevent accidental opening.

With the door 22 shut, an animal may approach the animal feeder 10 and be able to reach the hay within the housing 12 extending through the netting 44 in the area of the arched feeding openings 30. As the animal consumes the hay, the hay automatically gravity feeds to the lowest point within the housing 12. Thus, the animal owner can provide a multi-day amount of hay within the animal feeder 10 and allow the animal to feed at will. This will also prevent the animal from feeding off the hay at the top of the bales, a problem long associated with devices of the prior art.

With the divider walls 40 extending from the housing 12, each animal of a group of animals may feed at any one of the four areas or stalls 38 defined or provided by the construction of the divider walls 40. This creation of a stall or feeding area 38 prevents one animal from viewing another animal feeding at the adjoining stall. By preventing such viewing, the natural feeding hierarchy between animals is eliminating, thereby allowing each animal to feed in comfort and safety. This animal feeding hierarchy is a problem found in common area animal feeders wherein the superior animal will oftentimes prevent other inferior animals from eating or may harm other animals attempting to feed.

As such, an animal feeder comprises a movable housing having a floor, a roof, and a plurality of sidewalls extending between the floor and the roof, one of the sidewalls includes a door movable between an open position and a closed position, at least one sidewall has a feeding opening therethrough providing access to the interior of the housing through the feeding opening.

As an option, the door 22 may be removably mounted so that it may be removed for easier access to the interior of the housing.

It should be understood that multiple animal feeders 10 may be grouped together in a train-like fashion by coupling each animal feeder 10 to a link mountable within the hitch receiver 36. Thus, a tractor or other device may be coupled to the lead animal feeder 10 and be able to move all animal feeders within the train of animal feeders 10.

It should also be understood that by positioning the feeding openings 30 so that they extend from the floor of the animal feeder, the hay is positioned low within the housing 12. This positioning allows the animals to feed at a natural occurring neck and head down position, rather than having to feed over a barrier that causes the animals neck and head to be held at an unnaturally high position during the feeding process.

It should also be understood that the animal feeder 10 includes a floor 14, which elevates the hay above the ground to prevent the hay from absorbing moisture and rotting on the ground.

It will be appreciated that the inventions are susceptible to modification, variation and change without departing from the spirit thereof.

1. An animal feeder comprising:
a movable housing having a floor, a roof, and a plurality of sidewalls extending between said floor and said roof, one said sidewall including a door movable between an open position and a closed position, at least one said sidewall having a feeding opening therethrough providing access to the interior of said housing through said feeding opening.

2. The animal feeder of claim 1 wherein a plurality of said sidewalls include feeding openings therethrough providing access to the interior of said housing through said feeding openings.

3. The animal feeder of claim 1 wherein each sidewall includes a feeding opening therethrough providing access to the interior of said housing through said feeding opening.

4. The animal feeder of claim 2 further comprising at least one divider wall extending outwardly from said housing and positioned between adjacent feeding openings.

5. The animal feeder of claim 3 further comprising a plurality of divider walls extending outwardly from said housing, each said divider wall being positioned between adjacent feeding openings.

6. The animal feeder of claim 1 wherein said feeding opening extends upwardly from said housing floor.

7. The animal feeder of claim 1 wherein said housing further includes net mounting eyelets positioned within said housing.

8. The animal feeder of claim 7 further comprising a netting coupleable to said net mounting eyelets and positionable to cover said feeding opening.

9. The animal feeder of claim 1 further comprising a hitch receiver coupled to said housing.

10. An animal feeder comprising:
a housing having a floor, a roof, and a plurality of sidewalls extending between said floor and said roof;
a plurality of wall dividers extending outwardly from said housing, said wall dividers and said housing defining a plurality of feeding stalls, and
a plurality of animal feeding openings extending through said plurality of sidewalls, each said animal feeding opening of said plurality of animal feeding openings being positioned within one said feeding stall of said plurality of feeding stalls.

11. The animal feeder of claim 10 wherein said sidewalls includes an access door for access to the interior of said housing.

12. The animal feeder of claim 10 wherein said feeding openings extend upwardly from said housing floor.

13. The animal feeder of claim 10 wherein said housing further includes net mounting eyelets positioned within said housing.

14. The animal feeder of claim 13 further comprising a netting coupleable to said net mounting eyelets and positionable to cover said feeding opening.

15. The animal feeder of claim 10 further comprising a hitch receiver coupled to said housing.

16. An animal feeder comprising:
a housing having a floor, a roof, and sidewalls extending between said floor and said roof;
a plurality of feeding opening extending through said sidewalls, each said feeding opening extending upwardly from said floor, and
a door coupled to said sidewall providing access to the interior of said housing.

17. The animal feeder of claim 16 further comprising a pair of skids coupled to said housing.

18. The animal feeder of claim 16 further comprising a plurality of divider walls extending from said housing, each said divider wall of said plurality of divider walls being positioned between adjacent feeding openings.

19. The animal feeder of claim 16 wherein said housing further includes netting coupleable to said housing and positionable to cover said feeding opening.

20. The animal feeder of claim 16 further comprising a hitch receiver coupled to said housing.
